(19) United States
(12) Patent Application Publication
(10) Pub. No.: US 2019/0196032 A1
(43) Pub. Date: Jun. 27, 2019

(54) RADIATION DETECTION DEVICE

(71) Applicant: FUJIFILM Corporation, Tokyo (JP)

(72) Inventors: Hisatsugu HORIUCHI, Ashigarakami-gun (JP); Masateru TATEISHI, Ashigarakami-gun (JP); Shinsuke NOGUCHI, Ashigarakami-gun (JP)

(73) Assignee: FUJIFILM Corporation, Tokyo (JP)

(21) Appl. No.: 16/227,957

(22) Filed: Dec. 20, 2018

(30) Foreign Application Priority Data
Dec. 22, 2017 (JP) 2017-246645

(51) Int. Cl. G01T 7/00; G01T 1/20

(52) U.S. Cl. CPC G01T 7/00; G01T 1/2018

(57) ABSTRACT

A radiation detection device includes: a radiation detection panel; and a housing that accommodates the radiation detection panel, the housing includes: a front member in which a top plate covering a radiation incident surface of the radiation detection panel and an outer frame surrounding an outer periphery of the radiation detection panel are integrally formed; a back member that closes an opening portion, which is opposite to the top plate, of the front member; and a first sealing member that has a ring shape and is interposed between the front member and the back member, the back member includes an inner frame that is fitted inside the outer frame, and the first sealing member is interposed between the top plate and the inner frame in a fitting direction in which the inner frame is fitted to the outer frame.

### CROSS-REFERENCE TO RELATED APPLICATIONS

This application claims the benefit of Japanese Patent Application JP 2017-246645, filed Dec. 22, 2017, the entire content of which is hereby incorporated by reference, the same as if set forth at length.

### BACKGROUND OF THE INVENTION

### 1. Field of the Invention

The present invention relates to a radiation detection device.

### 2. Description of the Related Art

A so-called flat panel detector (FPD) is used to acquire a radiographic image of an object. The FPD comprises, for example, a scintillator that emits fluorescence corresponding to the amount of incident radiation and a detection substrate on which pixels detecting the fluorescence emitted from the scintillator are two-dimensionally arranged. Radiation transmitted through the object is incident on the scintillator and each pixel converts the fluorescence generated from the scintillator into an electric signal. Radiographic image data of the object is generated on the basis of the electric signal output from each pixel. A so-called electronic cassette in which an FPD is accommodated in a housing and which is portable has been known as a radiation detection device comprising the FPD.

A radiation detection device disclosed in JP2000-258541A comprises a detection surface cover portion forming a detection surface on which radiation is incident and a housing that accommodates a radiation detection unit, which is an FPD, and is bonded to the detection surface cover portion. The housing has a frame that surrounds the outer periphery of the radiation detection unit and a bottom that is formed integrally with the frame. The detection surface cover portion overlaps an opening portion of the frame and a sealing member is interposed between the detection surface cover portion and the frame.

In a cassette for radiography disclosed in JP2013-076783A, a housing that accommodates an FPD includes: a front member including a rectangular top plate portion and a frame portion that is vertically provided at the edges of four sides of the top plate portion; and a back member that closes an opening provided in the bottom of the front member. The top plate portion and the frame portion are integrally formed. A connection portion between the top plate portion and the frame portion is chamfered.

In an electronic cassette disclosed in JP2016-65728A, a housing accommodating an image detection unit which is an FPD has a substantially rectangular parallelepiped shape having a front surface, a rear surface, and four side surfaces. The front surface and the four side surfaces are integrally formed. The front surface and the four side surfaces are connected to a smooth curved surface.

### SUMMARY OF THE INVENTION

For example, an electronic cassette is inserted between the bed and an object that lies on his or her side on the bed and is then used. The load of the object is applied to the electronic cassette. In the radiation detection device disclosed in JP2000-258541A, the detection surface cover portion that comes into contact with the object is separated from the frame surrounding the outer periphery of the radiation detection unit. For example, in a case in which the radiation detection device is inserted between the object and the bed, there is a concern that the edge of the detection surface cover portion will be caught by the object and the rigidity of the detection surface cover portion against a load will be insufficient. Therefore, the radiation detection device needs to be handled with care.

In the cassette for radiography disclosed in JP2013-076783A, the top plate portion and the frame portion of the front member are integrally formed. Therefore, catching in a case in which the cassette is inserted between the object and the bed is prevented and the rigidity of the top plate portion and the frame portion is complementarily improved. However, the sealing between the front member and the back member that are separated from each other is not considered. In the electronic cassette disclosed in JP2016-65728A, the front surface and the four side surfaces are integrally formed. The sealing between the rear surface and the four side surfaces that are separated from each other is not considered. In a case in which a sealing performance is reduced, water is likely to be infiltrated into the housing and light is likely to be transmitted into the housing. There is a concern that, for example, the damage of the FPD and a radiation detection error will occur.

The invention has been made in view of the above-mentioned problems and an object of the invention is to provide a radiation detection device that is easy to handle and has a high sealing performance.

According to an aspect of the invention, there is provided a radiation detection device comprising: a radiation detection panel; and a housing that accommodates the radiation detection panel. The housing includes: a front member in which a top plate covering a radiation incident surface of the radiation detection panel and an outer frame surrounding an outer periphery of the radiation detection panel are integrally formed; a back member that closes an opening portion opposite to the top plate of the front member; and a first sealing member that has a ring shape and is interposed between the front member and the back member. The back member includes an inner frame that is fitted inside the outer frame. The first sealing member is interposed between the top plate and the inner frame in a direction in which the inner frame is fitted to the outer frame.

According to the invention, it is possible to provide a radiation detection device that is easy to handle and has a high sealing performance.

### BRIEF DESCRIPTION OF THE DRAWINGS

FIG. 1 is a perspective view illustrating an example of a radiation detection device for describing an embodiment of the invention.

FIG. 2 is a cross-sectional view taken along the line II-II of FIG. 1.

FIG. 3 is a plan view illustrating the radiation detection device illustrated in FIG. 1.

FIG. 4 is a cross-sectional view taken along the line Iv-Iv of FIG. 3.

FIG. 5 is a cross-sectional view illustrating a modification example of the radiation detection device illustrated in FIG. 1.

FIG. 6 is a diagram schematically illustrating an example of a reinforcing portion provided in a back member of the radiation detection device illustrated in FIG. 1.

FIG. 7 is a diagram schematically illustrating an example of the arrangement of engagement portions provided in the back member of the radiation detection device illustrated in FIG. 1.

### DESCRIPTION OF THE PREFERRED EMBODIMENTS

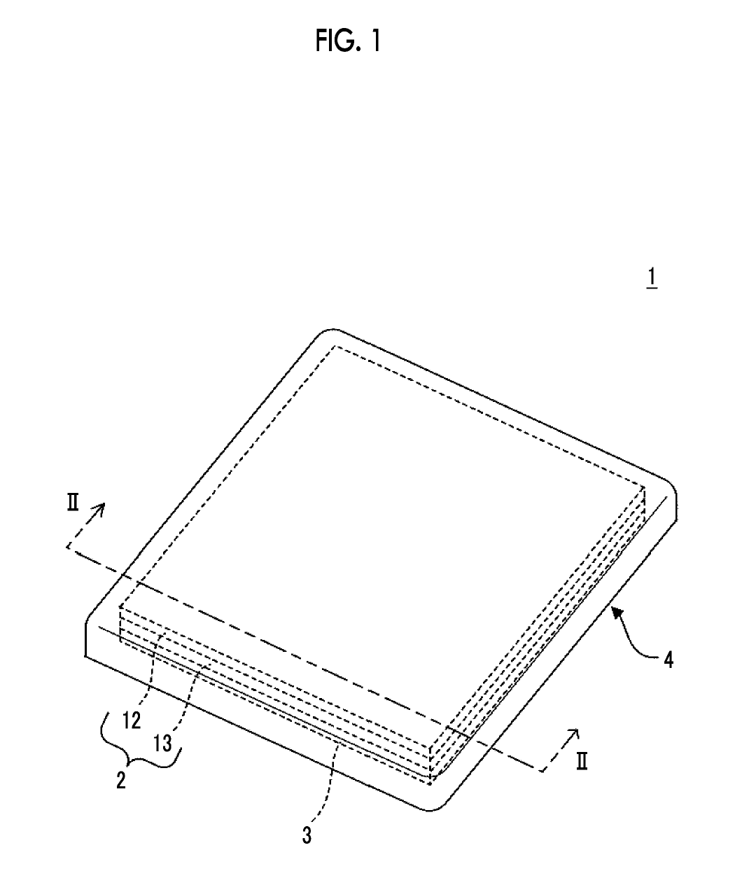

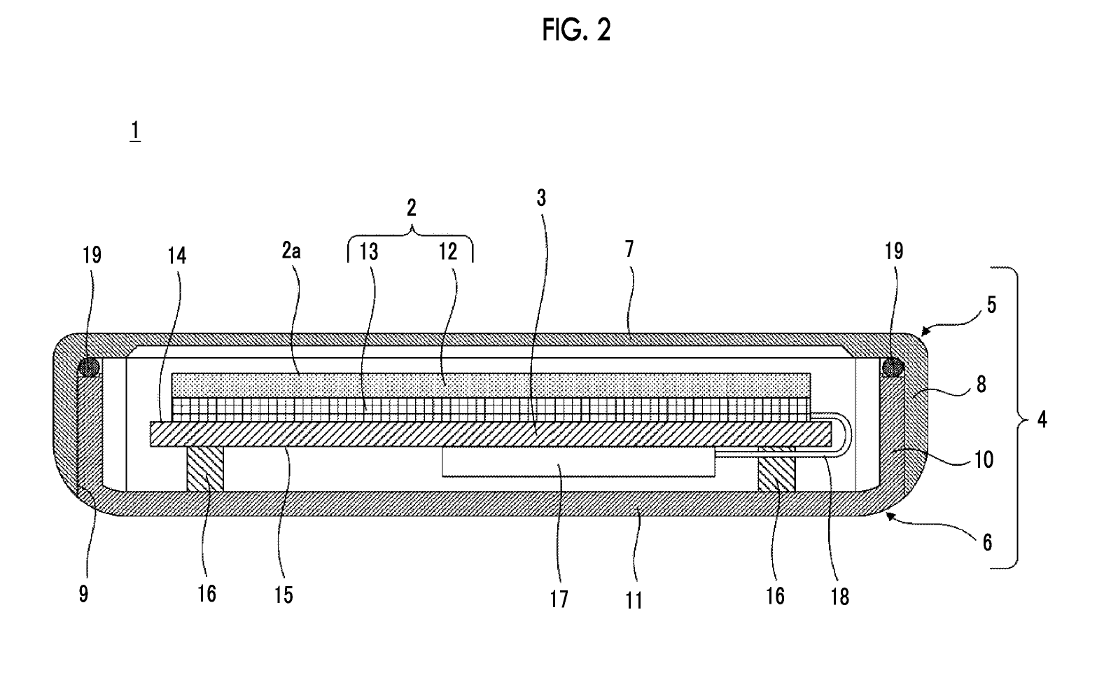

FIGS. 1 and 2 illustrate an example of a radiation detection device for describing an embodiment of the invention.

A radiation detection device 1 illustrated in FIGS. 1 and 2 is a so-called electronic cassette and comprises a radiation detection panel 2 that detects radiation, such as X-rays, a supporting member 3 that supports the radiation detection panel 2, and a housing 4 that accommodates the radiation detection panel 2 and the supporting member 3.

The housing 4 is formed in a rectangular parallelepiped shape and typically has a size based on the International Organization for Standardization (ISO) 4090:2001. The housing 4 includes a front member 5 and a back member 6.

In the front member 5, a top plate 7 that covers a radiation incident surface 2a of the radiation detection panel 2 and an outer frame 8 that surrounds the outer periphery of the radiation detection panel 2 are integrally formed. It is preferable that the front member 5 is made of a material which can reduce weight and increase load resistance. Examples of the material include a magnesium alloy, an aluminum alloy, a fiber reinforced resin, a cellulose nanofiber (CNF) reinforced resin, and a resin that satisfy a specific gravity of 3.0 or less and a Young's modulus of 1.8 GPa or more. The front member 5 is preferably made of a resin material, such as a fiber reinforced resin with high radiation transmittance, in consideration of the formation of the top plate 7 transmitting radiation.

In the back member 6, an inner frame 10 that is fitted inside the outer frame 8 and a bottom 11 that is provided in an opening portion 9 opposite to the top plate 7 of the front member 5 are integrally formed. The back member 6 closes the opening portion 9. It is preferable that the back member 6 is made of a material which can reduce weight and increase load resistance. Examples of the material include a magnesium alloy, an aluminum alloy, a fiber reinforced resin, a cellulose nanofiber (CNF) reinforced resin, and a resin that satisfy a specific gravity of 3.0 or less and a Young's modulus of 1.8 GPa or more.

The radiation detection panel 2 includes a scintillator 12 and a detection substrate 13 and is provided behind the top plate 7 in the housing 4. The scintillator 12 has a phosphor, such as CsI:Tl (thallium-activated cesium iodide) or GOS (Gd₂O₂S:Tb, terbium-activated gadolinium oxysulfide) and emits fluorescence corresponding to the amount of incident radiation. The detection substrate 13 includes a plurality of pixels that are two-dimensionally arranged, detects fluorescence generated by the scintillator 12 with the pixels, and converts the detected fluorescence into an electric signal.

In the example illustrated in FIGS. 1 and 2, the scintillator 12 and the detection substrate 13 are stacked in the order of the scintillator 12 and the detection substrate 13 from the top plate 7 of the housing 4. However, the scintillator 12 and the detection substrate 13 may be stacked in the order of the detection substrate 13 and the scintillator 12 from the top plate 7. In addition, a direct-conversion-type radiation detection panel may be used in which a photoconductive film of each pixel of the detection substrate 13 that generates signal charge is made of, for example, amorphous selenium and which directly converts radiation into signal charge.

The supporting member 3 is a plate-shaped member and is formed in a rectangular shape. In the specification, the rectangular shape is not limited to a quadrangle with right-angled corners and includes a quadrangle with chamfered corners or a quadrangle with rounded corners. The supporting member 3 has a first surface 14 that faces the top plate 7 of the housing 4 and a second surface 15 that is opposite to the first surface 14. The radiation detection panel 2 is supported by the first surface 14 of the supporting member 3. It is preferable that the supporting member 3 is made of a material which can reduce weight and increase load resistance. Examples of the material include a magnesium alloy, an aluminum alloy, a fiber reinforced resin, a cellulose nanofiber (CNF) reinforced resin, and a resin that satisfy a specific gravity of 3.0 or less and a Young's modulus of 1.8 GPa or more.

The supporting member 3 is supported by a plurality of spacers 16 provided on the second surface 15 of the supporting member 3. The spacers 16 are provided between the second surface 15 and the bottom 11 of the back member 6 which faces the second surface 15. An appropriate space is formed between the supporting member 3 and the bottom 11. The supporting member 3 is fixed to the back member 6 through the spacers 16.

The spacers 16 may be formed integrally with the supporting member 3. In a case in which the supporting member 3 is made of a metal material, such as an aluminum alloy or a magnesium alloy, the spacers 16 can be formed integrally with the supporting member 3 by, for example, casting or forging. In a case in which the supporting member 3 is made of a resin material, such as a fiber reinforced resin, the spacers 16 can be formed integrally with the supporting member 3 by, for example, vacuum molding. In addition, the spacers 16 may be formed separately from the supporting member 3 and may be bonded to the supporting member 3. In this case, the material forming the spacers 16 is not particularly limited. The spacers 16 may be brought into contact with the bottom 11 of the housing 4 through a buffer material such as elastomer.

A circuit substrate 17 is provided between the supporting member 3 and the bottom 11. For example, a driving control circuit that controls the driving of the detection substrate 13, a signal processing circuit that processes the electric signal output from the detection substrate 13, a communication circuit for communication with the outside, and a power circuit are formed on the circuit substrate 17. The circuit substrate 17 is schematically illustrated as a single element in FIG. 2. However, the circuit substrate 17 may be divided into a plurality of circuit substrates and the plurality of circuit substrates may be dispersed between the supporting member 3 and the bottom 11.

In addition, a power supply unit that supplies power to the detection substrate 13 and the circuit substrate 17 is provided between the supporting member 3 and the bottom 11, which is not illustrated in the drawings. The power supply unit is a rechargeable battery, such as a lithium-ion secondary battery, or a capacitor, such as an electric double layer capacitor or a lithium-ion capacitor.

The detection substrate 13 of the radiation detection panel 2 which is provided on the first surface 14 of the supporting member 3 and the circuit substrate 17 which is provided on the second surface 15 of the supporting member 3 are connected to each other by a plurality of flexible substrates 18. The flexible substrate 18 protrudes from the outer periphery of the radiation detection panel 2 to the outer frame 8 and the inner frame 10, is bent in an arch shape so as to pass between the supporting member 3 and the outer frame 8 and the inner frame 10 of the housing 4, and is connected to the circuit substrate 17.

The housing 4 further includes a first sealing member 19 that has a ring shape and is interposed between the front member 5 and the back member 6. The first sealing member 19 is an elastic body, such as silicone rubber or a foamed body, and is interposed between the top plate 7 and the inner frame 10 of the housing 4 in a direction in which the inner frame 10 is fitted to the outer frame 8 of the housing 4. The front member 5 and the back member 6 are fixed to each other. In a state in which the front member 5 and the back member 6 are fixed to each other, the first sealing member 19 comes into close contact with the top plate 7 and the inner frame 10 to prevent the infiltration of water into the housing 4 and the transmission of light into the housing 4.

Since the top plate 7 of the front member 5 and the outer frame 8 are integrally formed, the radiation detection device 1 is prevented from being caught in a case in which it is inserted between the object and the bed and it is easy to handle the radiation detection device 1. In addition, since the top plate 7 and the outer frame 8 are integrally formed, the rigidity of the front member 5 is improved. Similarly, since the inner frame 10 and the bottom 11 are integrally formed, the rigidity of the back member 6 is improved.

The warpage of the top plate 7 is prevented according to the improvement in the rigidity of the front member 5 and the falling of the inner frame 10 is prevented according to the improvement in the rigidity of the back member 6. Since the first sealing member 19 is interposed between the top plate 7 and the inner frame 10, the close contact of the first sealing member 19 with the top plate 7 and the inner frame 10 is maintained even in a case in which a load is applied to the radiation detection device 1. Therefore, it is possible to improve the sealing performance of the housing 4.

For example, the radiation detection device 1 is assembled as follows. First, the radiation detection panel 2 is bonded to the first surface 14 of the supporting member 3 and the circuit substrate 17 and the power supply unit are bonded to the second surface 15 of the supporting member 3. In this state, the supporting member 3 is fixed to the back member 6 through the plurality of spacers 16. Then, the first sealing member 19 is placed on the inner frame 10 of the back member 6 and the back member 6 is covered with the front member 5. As such, after the components accommodated in the housing, such as the radiation detection panel 2, the supporting member 3, the circuit substrate 17, and the power supply unit, are mounted and fixed to the back member 6, the front member 5 is attached. In this way, it is possible to improve assembly workability.

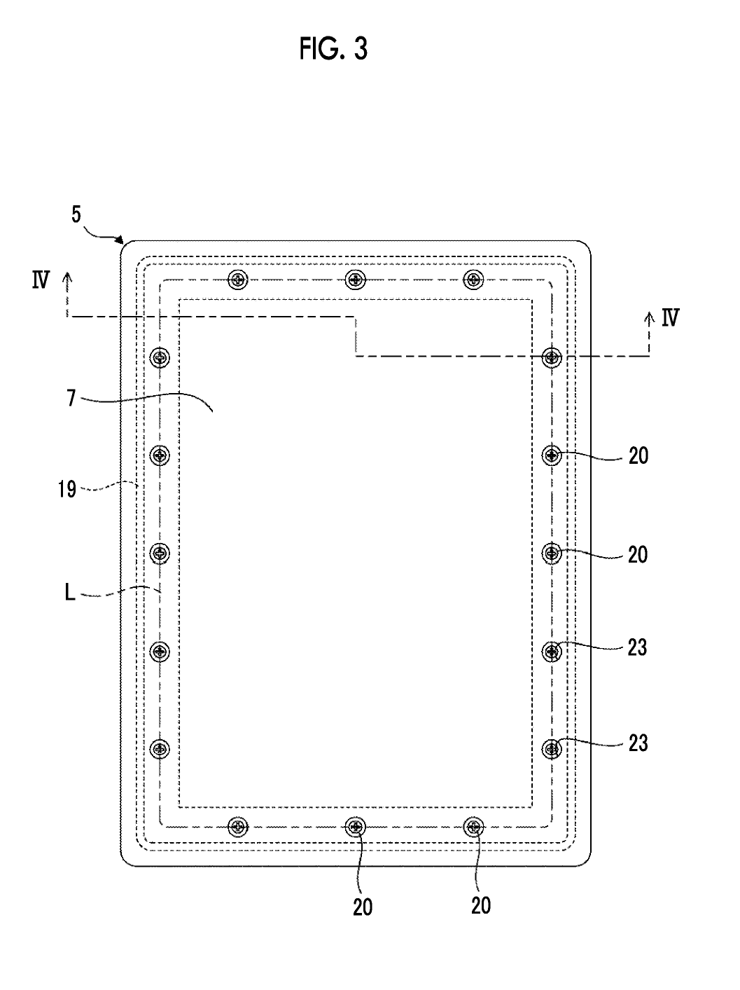

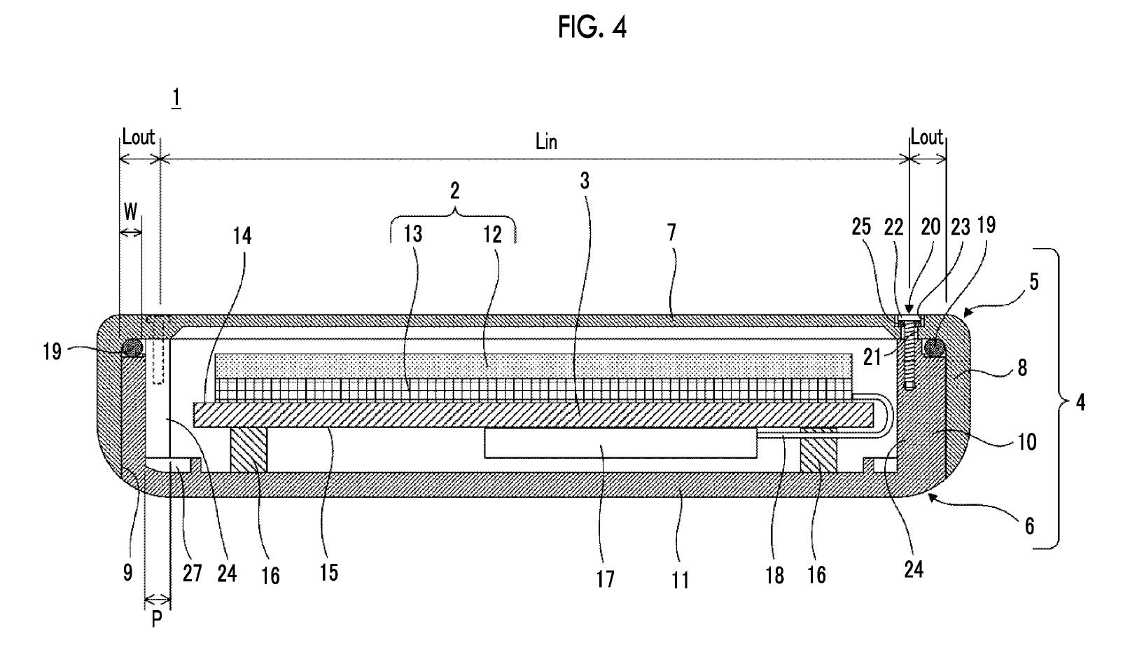

FIGS. 3 and 4 illustrate an example of the arrangement of fastening members for fixing the front member 5 and the back member 6.

The housing 4 further includes a plurality of screws 20 as the fastening members for fixing the front member 5 and the back member 6. The screws 20 are provided at appropriate intervals along four sides of the top plate 7 of the front member 5 and couple the top plate 7 to the inner frame 10 in the direction in which the inner frame 10 of the back member 6 is fitted to the outer frame 8 of the front member 5.

The screws 20 pass through the top plate 7 and are engaged with the inner frame 10 of the back member 6. Through holes 21 are formed in the top plate 7 and concave portions 23 that accommodate head portions 22 of the screws 20 passing through the through holes 21 are formed in the outer surface of the top plate 7. Engagement portions 24 that are engaged with the screws 20 are provided in the inner frame 10 and screw holes are formed in the engagement portions 24. The engagement portions 24 protrude from the inner surface of the inner frame 10 to the radiation detection panel 2 and the supporting member 3 and are formed integrally with the inner frame 10. The screw 20 may pass through the inner frame 10 of the back member 6 and may be engaged with the top plate 7 of the front member 5. In this case, the through holes are formed in the engagement portions 24 of the inner frame 10 and the screw holes are formed in the top plate 7.

The outer frame 8 and the inner frame 10 may be coupled to each other in a direction intersecting the direction in which the inner frame 10 is fitted to the outer frame 8. Since the top plate 7 and the inner frame 10 are coupled to each other in the direction in which the inner frame 10 is fitted to the outer frame 8, it is possible to reliably compress the first sealing member 19 interposed between the top plate 7 and the inner frame 10 in the fitting direction and thus to improve the sealing performance of the housing 4.

The screws 20 are arranged inside the first sealing member 19 with a ring shape. The screws 20 may be arranged outside the first sealing member 19. Since the screws 20 are arranged inside the first sealing member 19, it is possible to increase the width W of the first sealing member 19 and to improve the sealing performance of the housing 4. The screws 20 and the engagement portions 24 are arranged at appropriate intervals. In a case in which the screws 20 are arranged outside the first sealing member 19, the first sealing member 19 is retreated to the inside of the housing 4 over the entire periphery by a distance corresponding to the amount of protrusion P of the engagement portion 24. The inner surface of the inner frame 10 that faces the top plate 7 with the first sealing member 19 interposed therebetween is also retreated to the inside of the housing 4 over the entire periphery. Therefore, the clearance between the inner frame 10, and the radiation detection panel 2 and the supporting member 3 is reduced over the entire periphery. The width W of the first sealing member 19 is reduced in order to ensure the clearance. In contrast, in a case in which the screws 20 are arranged inside the first sealing member 19, the clearance is reduced by the engagement portion 24 protruding from the inner surface of the inner frame 10 at the position where the screws are arranged. However, the clearance is relatively large between two adjacent screw arrangement positions, that is, between two adjacent engagement portions 24. Therefore, it is possible to ensure the clearance and to increase the width W of the first sealing member 19 by arranging the screws 20 except a housing part in which a relatively large deformation is expected to occur in a case in which the radiation detection device 1 falls on, for example, a floor.

Preferably, the screws 20 are provided along four sides of the top plate 7 except four corners of the top plate 7, as illustrated in FIG. 3. A relatively large deformation is expected to occur at the corners of the housing 4 in a case in which the radiation detection device 1 falls on, for example, a floor. However, since the screws 20 are provided except four corners of the top plate 7, the clearance between the inner frame 10, and the radiation detection panel 2 and the supporting member 3 is ensured at the corners. Therefore, it is possible to prevent the collision of the inner frame 10 with the radiation detection panel 2 and the supporting member 3 caused by the deformation of the corners and to prevent the damage of the radiation detection panel 2.

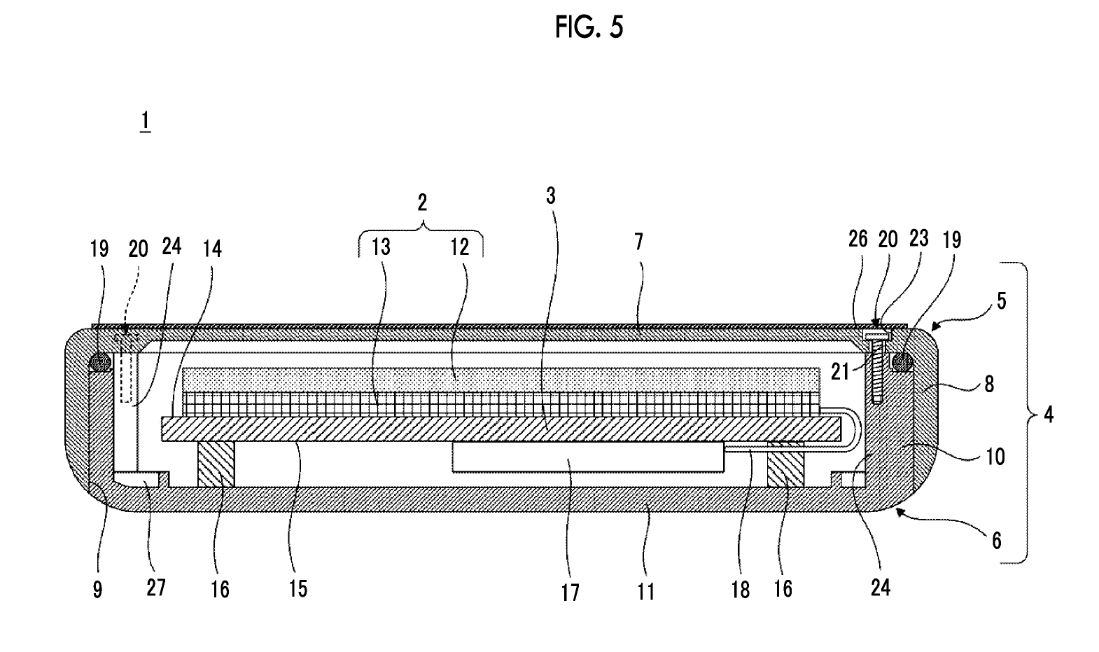

Since the screws 20 are arranged inside the first sealing member 19, the through holes 21 of the top plate 7 directly communicate with the inside of the housing 4. The housing 4 includes second sealing members that seal the through holes 21. In the example illustrated in FIG. 4, the second sealing member is an O-ring 25 that is attached to the screw 20. The O-ring 25 is interposed between the head portion 22 of the screw 20 and the concave portion 23 in the outer surface of the top plate 7. The second sealing member is not limited to the O-ring. As illustrated in FIG. 5, the second sealing member may be a sheet 26 that is attached to the outer surface of the top plate 7 to close the concave portions 23. Even in a case in which the through hole is formed in the engagement portion 24 of the inner frame 10 instead of the top plate 7, the second sealing member, such as the O-ring 25 and the sheet 26, can be applied.

Preferably, reinforcing portions 27 are provided at four corners of the bottom 11 of the back member 6, as illustrated in FIG. 4. The screws 20 are not provided at four corners of the top plate 7 and the compression of the first sealing member 19 based on the coupling between the top plate 7 and the inner frame 10 through the screws 20 is relatively weak at the four corners of the top plate 7. Since the reinforcing portions 27 are provided at four corners of the bottom 11, it is possible to prevent the warpage of the four corners of the bottom 11 caused by the reaction force of the first sealing member 19 and to compensate for the compression of the first sealing member 19.

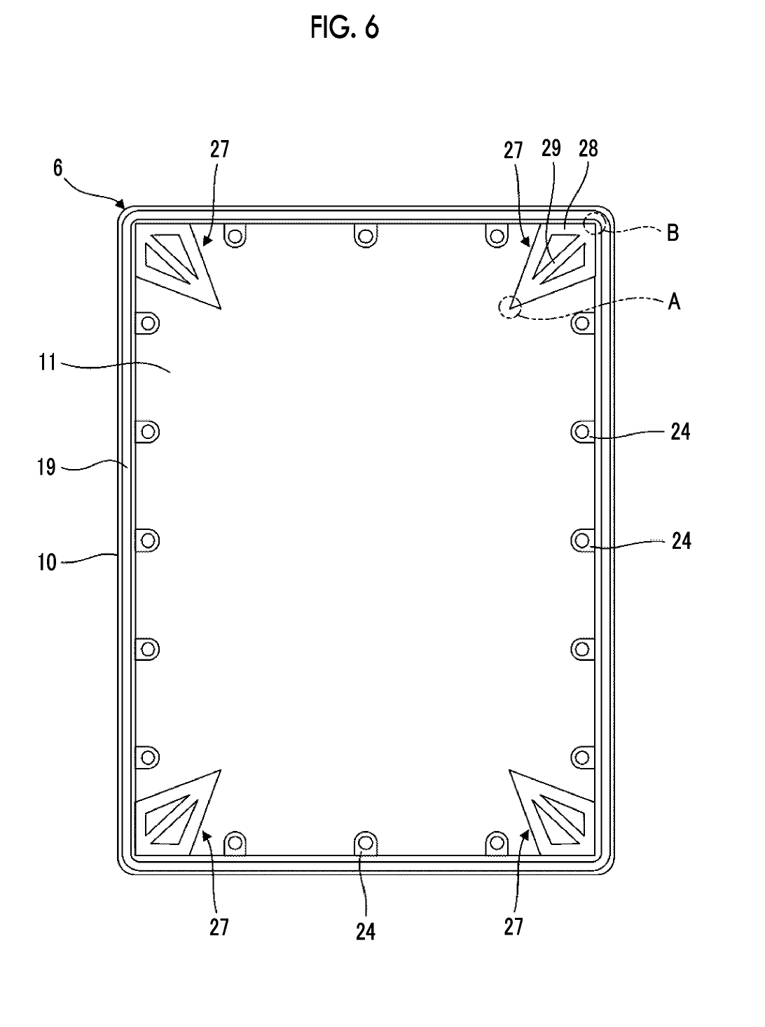

The reinforcing portions 27 provided at four corners of the bottom 11 may be, for example, ribs that protrude from the bottom 11 to the top plate 7 as illustrated in FIG. 6. In the example illustrated in FIG. 6, the reinforcing portion 27 includes two ribs, that is, a quadrangular rib 28 having one corner A that faces the center of the bottom 11 and a rib 29 that connects the corner A and an opposing corner B. The reinforcing portion 27 is not limited to the example illustrated in FIG. 6 as long as it can prevent the warpage of the four corners of the bottom 11.

Preferably, a region Lₒᵤₜ outside a frame line L (see FIG. 3) that is formed by connecting the screws 20 along four corners of the top plate 7 is thicker than a region Lᵢₙ inside the frame line L in the top plate 7, as illustrated in FIG. 4. This configuration makes it possible to increase the rigidity of the front member 5, without reducing radiation transmittance. Even in a case in which a load is applied to the radiation detection device 1, it is possible to maintain the close contact of the top plate 7 and the inner frame 10 with the first sealing member 19 and to improve the sealing performance of the housing 4.

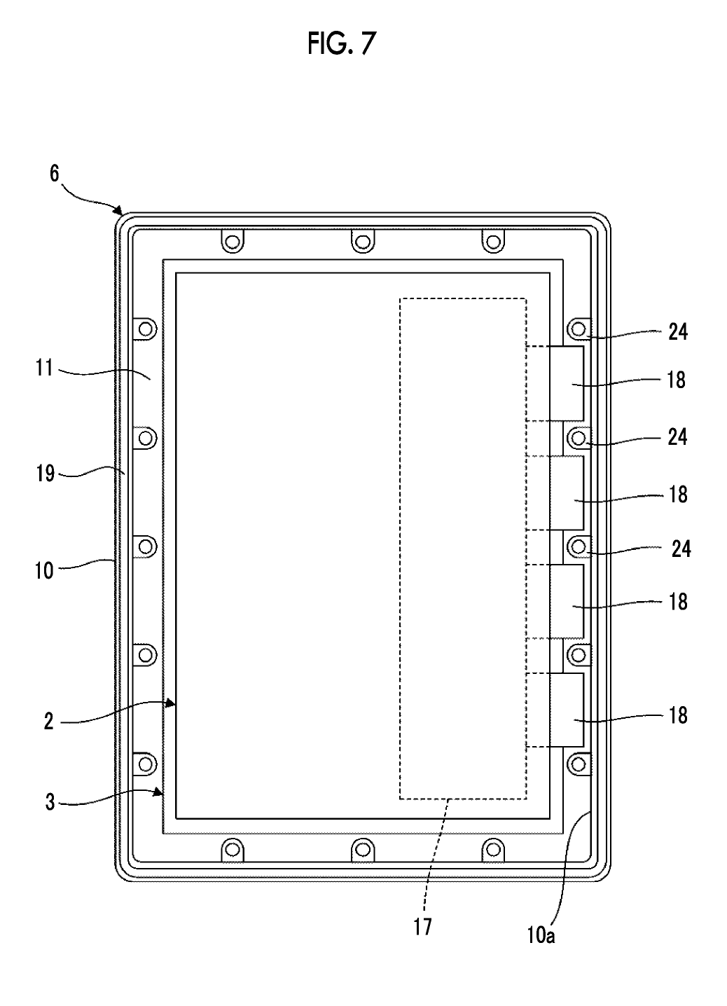

FIG. 7 illustrates an example of the arrangement of the engagement portions 24, which are engaged with the screws 20, on the inner frame 10.

In the example illustrated in FIG. 7, the flexible substrates 18 connecting the radiation detection panel 2 and the circuit substrate 17 are arranged at intervals along the edge (one side) of at least a portion of the outer periphery of the radiation detection panel 2. The engagement portions 24 are provided on one surface 10a of the inner frame 10 which faces one side of the radiation detection panel 2 along which the flexible substrates 18 are arranged. The engagement portions 24 protrude from the one surface 10a of the inner frame 10 to the radiation detection panel 2 and the supporting member 3. The engagement portion 24 is provided between two adjacent flexible substrates 18.

Since the engagement portion 24 is provided between two adjacent flexible substrates 18, it is possible to ensure the clearance between the engagement portion 24, and the radiation detection panel 2 and the supporting member 3 and the clearance between the flexible substrate 18 and the inner frame 10, to widen the radiation detection panel 2 and the supporting member 3, and expand an effective pixel region of the radiation detection panel 2 (detection substrate 13).

As described above, a radiation detection device disclosed in the specification comprises a radiation detection panel and a housing that accommodates the radiation detection panel. The housing includes: a front member in which a top plate covering a radiation incident surface of the radiation detection panel and an outer frame surrounding an outer periphery of the radiation detection panel are integrally formed; a back member that closes an opening portion opposite to the top plate of the front member; and a first sealing member that has a ring shape and is interposed between the front member and the back member. The back member includes an inner frame that is fitted inside the outer frame. The first sealing member is interposed between the top plate and the inner frame in a direction in which the inner frame is fitted to the outer frame.

In the radiation detection device disclosed in the specification, the housing includes a plurality of fastening members that couple the top plate to the inner frame in the fitting direction.

In the radiation detection device disclosed in the specification, the fastening members are provided inside the first sealing member.

In the radiation detection device disclosed in the specification, the fastening member passes through one of the top plate and the inner frame and is engaged with the other. The housing includes a second sealing member that seals a through hole formed in the top plate or the inner frame.

The radiation detection device disclosed in the specification further comprises: a circuit substrate that is provided on a rear surface side opposite to the radiation incident surface of the radiation detection panel and is accommodated in the housing; and a plurality of flexible substrates that connect the radiation detection panel and the circuit substrate. The flexible substrates are arranged at intervals along an edge of at least a portion of the outer periphery of the radiation detection panel and protrude from the outer periphery of the radiation detection panel to the outer frame and the inner frame while being bent in an arch shape. The inner frame includes engagement portions which are engaged with the fastening members and each of which is provided between two adjacent flexible substrates.

In the radiation detection device disclosed in the specification, the housing has a rectangular parallelepiped shape and the fastening members are provided along four sides of the top plate except four corners of the top plate.

In the radiation detection device disclosed in the specification, the back member has a bottom provided in the opening portion and reinforcing portions are provided at four corners of the bottom.

In the radiation detection device disclosed in the specification, the reinforcing portion is one or more ribs that protrude from the bottom to the top plate.

In the radiation detection device disclosed in the specification, a region outside a frame line that is formed by connecting the fastening members along the four sides of the top plate is thicker than a region inside the frame line in the top plate.

### EXPLANATION OF REFERENCES

1: radiation detection device
2: radiation detection panel
2a: radiation incident surface of radiation detection panel
3: supporting member
4: housing
5: front member
6: back member
7: top plate
8: outer frame
9: opening portion of outer frame
10: inner frame
10a: one surface of inner frame
11: bottom
12: scintillator
13: detection substrate
14: first surface of supporting member
15: second surface of supporting member
16: spacer
17: circuit substrate
18: flexible substrate
19: first sealing member
20: screw (fastening member)
21: through hole
22: head portion of screw
23: concave portion
24: engagement portion
25: O-ring (second sealing member)
26: sheet (second sealing member)
27: reinforcing portion
28: rib
29: rib
A: corner
B: opposing corner
L: frame line
Lₒᵤₜ: region outside frame line
Lᵢₙ: region inside frame line
P: amount of protrusion of engagement portion
W: width of first sealing member

What is claimed is:

1. A radiation detection device comprising:
a radiation detection panel; and
a housing that accommodates the radiation detection panel,
wherein the housing comprises:
a front member in which a top plate covering a radiation incident surface of the radiation detection panel and an outer frame surrounding an outer periphery of the radiation detection panel are integrally formed;
a back member that closes an opening portion, which is opposite to the top plate, of the front member; and
a first sealing member that has a ring shape and is interposed between the front member and the back member,
the back member comprises an inner frame that is fitted inside the outer frame, and
the first sealing member is interposed between the top plate and the inner frame in a fitting direction in which the inner frame is fitted to the outer frame.

2. The radiation detection device according to claim 1,
wherein the housing comprises a plurality of fastening members that couple the top plate to the inner frame in the fitting direction.

3. The radiation detection device according to claim 2,
wherein the fastening members are provided inside the first sealing member.

4. The radiation detection device according to claim 3,
wherein the fastening members pass through one of the top plate and the inner frame and are engaged with other of the top plate and the inner frame.

5. The radiation detection device according to claim 4,
wherein the housing comprises a second sealing member that seals a through hole formed in the top plate or the inner frame.

6. The radiation detection device according to claim 3, further comprising:
a circuit substrate that is provided on a rear surface side of the radiation detection panel opposite to the radiation incident surface and is accommodated in the housing; and
a plurality of flexible substrates that connect the radiation detection panel and the circuit substrate,
wherein the flexible substrates are arranged at interval along an edge of at least a portion of the outer periphery of the radiation detection panel and protrude from the outer periphery of the radiation detection panel toward the outer frame and the inner frame while being bent in an arch shape, and
the inner frame comprises engagement portions which are engaged with the fastening members and each of which is provided between two adjacent ones of the flexible substrates.

7. The radiation detection device according to claim 4, further comprising:
a circuit substrate that is provided on a rear surface side of the radiation detection panel opposite to the radiation incident surface and is accommodated in the housing; and
a plurality of flexible substrates that connect the radiation detection panel and the circuit substrate,
wherein the flexible substrates are arranged at interval along an edge of at least a portion of the outer periphery of the radiation detection panel and protrude from the outer periphery of the radiation detection panel toward the outer frame and the inner frame while being bent in an arch shape, and
the inner frame comprises engagement portions which are engaged with the fastening members and each of which is provided between two adjacent ones of the flexible substrates.

8. The radiation detection device according to claim 5, further comprising:
a circuit substrate that is provided on a rear surface side of the radiation detection panel opposite to the radiation incident surface and is accommodated in the housing; and
a plurality of flexible substrates that connect the radiation detection panel and the circuit substrate,
wherein the flexible substrates are arranged at interval along an edge of at least a portion of the outer periphery of the radiation detection panel and protrude from the outer periphery of the radiation detection panel toward the outer frame and the inner frame while being bent in an arch shape, and
the inner frame comprises engagement portions which are engaged with the fastening members and each of which is provided between two adjacent ones of the flexible substrates.

9. The radiation detection device according to claim 3,
wherein the housing has a rectangular parallelepiped shape, and
the fastening members are provided along four sides of the top plate except four corners of the top plate.

10. The radiation detection device according to claim 4,
wherein the housing has a rectangular parallelepiped shape, and
the fastening members are provided along four sides of the top plate except four corners of the top plate.

11. The radiation detection device according to claim 5,
wherein the housing has a rectangular parallelepiped shape, and
the fastening members are provided along four sides of the top plate except four corners of the top plate.

12. The radiation detection device according to claim 9,
wherein the back member has a bottom provided in the opening portion, and
reinforcing portions are provided at four corners of the bottom.

13. The radiation detection device according to claim 10,
wherein the back member has a bottom provided in the opening portion, and
reinforcing portions are provided at four corners of the bottom.

14. The radiation detection device according to claim 11,
wherein the back member has a bottom provided in the opening portion, and
reinforcing portions are provided at four corners of the bottom.

15. The radiation detection device according to claim 12,
wherein each of the reinforcing portions is one or more ribs that protrude from the bottom toward the top plate.

16. The radiation detection device according to claim 13,
wherein each of the reinforcing portions is one or more ribs that protrude from the bottom toward the top plate.

17. The radiation detection device according to claim 14,
wherein each of the reinforcing portions is one or more ribs that protrude from the bottom toward the top plate.

18. The radiation detection device according to claim 9,
wherein a region outside a frame line that is formed by connecting the fastening members along the four sides of the top plate is thicker than a region inside the frame line in the top plate.

19. The radiation detection device according to claim 12,
wherein a region outside a frame line that is formed by connecting the fastening members along the four sides of the top plate is thicker than a region inside the frame line in the top plate.

20. The radiation detection device according to claim 1, further comprising:
a supporting member that supports the radiation detection panel at a first surface of the supporting member; and
a plurality of spacers that are provided between a second surface of the supporting member being opposite to the first surface and a bottom of the back member which faces the second surface,
wherein the supporting member is fixed to the back member through the plurality of spacers.
